(19) United States
(12) Patent Application Publication
(10) Pub. No.: US 2012/0185293 A1
(43) Pub. Date: Jul. 19, 2012

(54) WORKFLOW MANAGEMENT SYSTEM AND METHOD FOR IMPLEMENTING WORKFLOW DEFINITION TOOL

(76) Inventors: Zhaohui Wu, Hangzhou (CN); Bin Wu, Hangzhou (CN); Jian Wu, Hangzhou (CN); Shuiguang Deng, Hangzhou (CN); Ying Li, Hangzhou (CN); Jianwei Yin, Hangzhou (CN)

(21) Appl. No.: 13/498,565

(22) PCT Filed: Apr. 7, 2010
(86) PCT No.: PCT/CN2010/071607

§ 371 Date: Mar. 27, 2012

(30) Foreign Application Priority Data
Sep. 28, 2009 (CN) 200910152767.5

(51) Int. Cl. G06Q 10/06

(52) U.S. Cl. 705/7.26

(57) ABSTRACT

The present invention provides a workflow management system and a method for implementing a workflow definition tool. The workflow management system comprises a computer, and a workflow definition tool and a workflow engine in the computer, wherein: the workflow definition tool directly represents a process as process definition codes which are computer executable, and the workflow engine directly calls the process definition codes. When the workflow changes, the system of the present invention will only need to correspondingly modify the workflow definition tool instead of modifying the codes of the workflow engine, thus the development, maintenance and use of the workflow management system are facilitated.

This is a U.S. national stage application of PCT Application No. PCT/CN2010/071607 under 35 U.S.C. 371, filed Apr. 7, 2010 in Chinese, claiming the priority benefits of Chinese Application No. 200910152767.5, filed Sep. 28, 2009, which is hereby incorporated by reference.

### TECHNICAL FIELD

The present invention relates to workflow technical field, especially a workflow management system and a method for implementing the workflow definition tool.

### BACKGROUND OF THE ART

A workflow is a computing model of business processes, which presents the orderly organizing logic and rules of tasks in business processes using appropriate models and implements computation on these models. The main problem workflows attempt to solve is the automation problem of the transmission of documents, information and tasks between participators by some predefined rules in computers for a specific business target. Workflow is a part of computer supported collaboration, which generally researches on how a group can cooperate together with the help of computers. The main functionalities of the workflow management system include using computer technology to define, execute and manage workflows, and coordinate the information exchange of tasks in the executing process of workflows and of individuals in the group. Workflow needs workflow management system to implement.

The existing workflow management generally includes a workflow definition tool and a workflow engine. The workflow definition tool adopts proper modeling technology to model workflows of the workflow management system. The workflow engine manages the life cycle of business processes by parsing process definition information generated by the workflow definition tool, including creating of process instances, generating of work item, controlling of routing and so on.

With the expansion of the application domain of workflow management systems, the drawbacks of different kinds of workflow products in the modeling problem become increasingly obvious. Most existing workflow products build on the reference model presented by WFMC (Workflow Management Coalition). Although the WFMC reference model admits that there is no unified method for workflow modeling, using meta-data modeling technology is the simplest and most efficient method generally accepted by people. The meta-data is the process definition data that the workflow engine understands. When the workflow reference model is proposed, this type of modeling method based on meta-data has positive effects and can easily achieve the conversion from process modeling requirements to meta-data through various definition tools. However, with the expansion of the application fields, the problem of limited modeling scope of the meta-data technology becomes increasingly obvious. The developers of the workflow management system need to determine the modeling requirements of business processes and to design the meta-data sets according to the modeling requirements before system development. Unfortunately, during the application of the workflow management system, the modeling requirements of users continuously change. This forces the workflow management system developers to expand the meta-data set and modify the source code of the workflow engine to adapt to the changes of the modeling requirements. To the development, maintaining and use of workflow management system, it is a disaster. Therefore, adapting to the changing requirements without modifying the source code of the workflow engine is a development trend of workflow management system in future.

### DISCLOSURE OF THE INVENTION

### Technical Problem

This invention aims at the problem that the existing workflow management cannot satisfy the complex and changing process modeling requirements, and presents a workflow management and a method for implementing the definition tool.

### Technical Solution

In order to solve the technical problem, this invention presents a workflow management system, including a computer, a workflow definition tool and a workflow engine in the computer. The workflow definition tool directly models business process as workflow definition codes which can be executed by computers. The workflow engine directly executes the workflow definition codes.

The workflow management presented by this invention directly presents processes as computer executable codes. The workflow engine directly invokes these codes without parsing the process definition. When the business process changes, only the workflow definition tool needs to be modified without the need to modify workflow engine codes. This significantly facilities the development, maintenance and use of the workflow management system.

In addition, this invention presents a method for implementing the workflow definition tool. This method directly represents processes as computer executable definition codes, includes:

step 1: implementing the process interface, which defines the global functionalities of processes in a coding manner;

step 2: implementing the data interface, which defines the rules for data reading and writing in a coding manner;

step 3: implementing the activity interface, which defines the functionality of every activity in a business process in a coding manner;

step 4: implementing the work item interface, which defines the specific tasks of process activities in a coding manner.

### Benefits

This invention directly represents processes as computer executable process definition codes, and can implement the workflow definition tools in the workflow management flexibly according to the change of business processes. Thus, it facilities the development, the maintenance and use of the workflow management system greatly.

### BRIEF DESCRIPTIONS OF THE DRAWINGS

FIG. 1 depicts the structure of the workflow management system presented in this invention.

FIG. 2 is the flow chart of this invention.

### IMPLEMENTATION EMBODIMENTS OF THE INVENTION

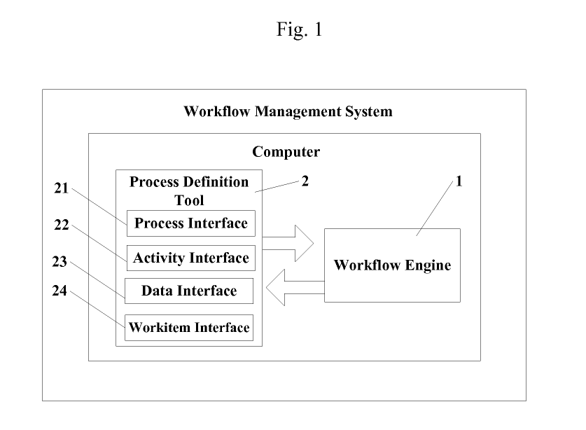

FIG. 1 is the structure diagram of the workflow management system in this invention. The workflow management system includes a computer, a workflow definition tool 2 in the computer and a workflow engine 1 in the computer. The workflow definition tool 2 generates process definition information, and represents processes as computer executable process definition codes. The workflow engine 1 directly invokes the process definition codes and controls the process execution. The workflow definition tool 2 in this invention does not represent processes as computer processable data, instead it directly represents processes as executable codes. The engine has no need to parse the workflow definition, but directly invokes the process definition codes. This invention can satisfy the complex process modeling requirements without modifying the codes of workflow engines, thus can really achieves the technical results of change on demand. It is completely free from the traditional process modeling technology using the meta-data.

After sufficiently summarizing various the workflow modeling requirements, it has been found that no matter how complex the process definition is, it can be classified into four categories of interfaces. The interfaces described here refer to the functional description of business processes, but not specific details of implementation. As shown in FIG. 1, these four kinds of interfaces are process interface 21, activity interface 22, data interface 23 and task item interface 24. The following gives concrete details about these four kinds of interfaces.

The process interface 21 defines the global functionalities of processes in a coding manner. The global functionalities include the acquisition of the candidate executors, the start of the business process and the finish of the business process. The acquisition of the candidate executors means the way that processes retrieve the executors, and the determination process through which various process executors can be chosen. The start of business processes refers to the activating process of workflows. Generally, the starting process can create a corresponding process instance, and specific starting operation can also be added here. The finish of business processes refers to cleaning up after the process execution, generally including the recording process of logs.

The activity interface 22 defines the functionality of every activity in a coding manner. During the modeling process, a business process generally includes a series of nodes (called activities) and transitions between nodes (called links) Process definition determines every activity, thus every activity needs to implement this interface. For an activity interface, it includes the activity activation function, activity completion function and activity execution function. The activation of activities refers to the activation condition, which usually depends on the links from previous nodes to current node. Of course, more complex activation condition can be implemented, for example, the adding of the expressions, compound linking in relations and so on. The completion of activities refers to operations after activity execution, generally activating the next activity, may also include retrieving the resources used in the activities. The execution of activities refers to specific operations during the life time of activities, generally including the generating of the activity instances and work item instances.

The data interface 23 defines the rules for data reading and writing in a coding manner. Processes contain some process data, and the execution of activities is the operation process of process data. The data interface includes data reading and writing functionalities. Data reading means how to control the reading of process data, for example, to determine which activities or users can read the data. Data writing means how to control the writing of process data, including the control of writing authority and concurrency.

The task item interface 24 defines the specific tasks of process activities in a coding manner. Here, this invention limits every activity has only one work item. These tasks include the acquisition of the task executor, the preparation of the work item and the operating interfaces of the end users, the completion of the work item, and the transmission of the work item. The acquisition of the task executor refers to the determination of the end users who can execute this task, which is also the activity participant. The preparing of the work item and the operating interfaces of the end users means how to show the end user interface, generally including reading data from the workflow engine by the data interface for the end user to read, and displaying the user interface for end user writing and writing data to the workflow engine by the data writing interface. The completion of the work item refers to specific finishing operations, generally triggering the finishing operation of the corresponding activity. The forwarding transmission of the work item means transmitting the work item from one executor to another.

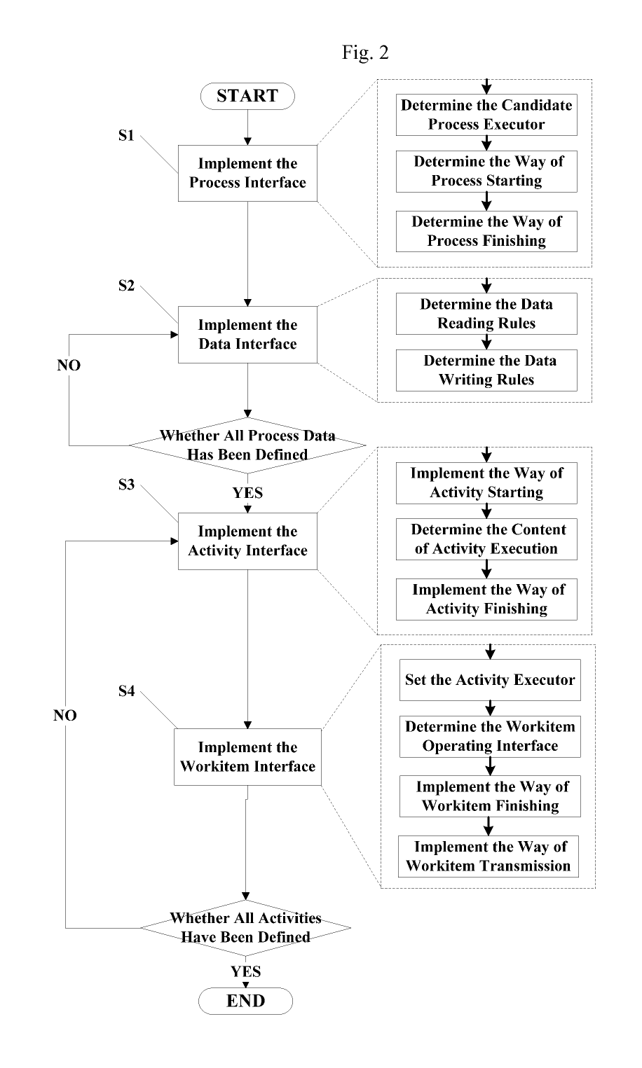

FIG. 2 is the flow chat of the method for implementation a workflow definition tool according to the present invention. The dashed rectangles represent sub-steps for each step. As shown in FIG. 2, according to the method, step S1 is firstly performed to implement the process interface. This step includes the determination of the candidate executors, the start of the process and the finish of the process. After step S1, step S2 implements the data interface, which determines the rules for data reading and writing for all process data. After step S2, the method judges whether all process data has been defined. If the definition is not completed, then the method goes back to step S2. Otherwise, it moves to step S3. The step S3 implements the activity interface to determine the functionality of every activity, including the activation of every activity, the determination of the execution content and the finish of every activity. After step S3, step S4 implements the work item interface corresponding to every activity, including the establishing the task executor, the determining the work item operating interfaces, realization of the task completion operation and realization of the task forwarding transmission manner. After step S4, the method judges whether all activities have been defined. If they have not been defined, then it goes back to step S3. If they are completed, the method ends.

In essence, the process modeling requirements all can be expressed by codes. The workflow definition tool in this invention represents processes as computer executable process definition codes by direct coding or assisting tools. According to the direct coding method, modeling persons (with programming experience) sequentially implement all process definition interfaces using the programming language which is the same as the implementing language for workflow engine through the process shown in FIG. 2. In addition, for the high technical complexity problem in direct coding manner, proper middle assisting tools can be used to simplify the modeling process. The vendors of the workflow management system can offer some middle assisting tool to support development in order to simplify the coding process. These assisting tools encapsulate general functionalities to support direct use by the end users> For example, the example operations of processes and activities can be provided to modeling person in the form of a library. The modeling person can directly utilize the methods in the library to implement workflow interfaces.

### INDUSTRIAL APPLICATION

This invention can be used in a large scale in industry.

1. A workflow management system, including a computer, a workflow definition tool and a workflow engine in the computer, characterized in that:
the workflow definition tool directly represents processes as workflow definition codes which can be executed by computers;
the workflow engine directly calls the workflow definition codes.

2. The workflow management system described in claim 1, characterized in that: the workflow definition tool includes a process interface, an activity interface, a data interface and a work item interface;
the process interface is used to define global functionalities of a process in a coding manner;
the activity interface is used to define functionality of every activity in the process in a coding manner;
the data interface is used to define the rules for data reading and writing in a coding manner; and
the work item interface is used to define the specific tasks of process activities in a coding manner.

3. The workflow management system described in claim 2, characterized in that: the global functionalities of the process include functions of acquiring candidate executors, starting the process and finishing the process.

4. The workflow management system described in claim 2, characterized in that: the functionalities of each activity in the process include functions of activating the activity, finishing the activity and executing the activity.

5. The workflow management system described in claim 2, characterized in that: the specific tasks include acquiring a task executor, preparing an operation interface between a work item and an end user, finishing the work item and forwarding the work item.

6. A method implementing the workflow definition tool, characterized in that: the method directly models processes as workflow definition codes which can be executed by computers, including:
Step 1: implementing a process interface, which defines global functionalities of a process in a coding manner.
Step 2: implementing a data interface, which defines rules for data reading and writing in a coding manner.
Step 3: implementing an activity interface, which defines functionality of every activity in the process in a coding manner.
Step 4: implementing a work item interface, which defines specific tasks of process activities in a coding manner.

7. The method implementing the workflow definition tool described in claim 6, characterized in that: the step 1 determines candidate executors of the process, starting way of the process and the finishing way of the process.

8. The method implementing the workflow definition tool described in claim 6, characterized in that: the step 3 implements activating way of the activities, determines execution contents of the activities and finishing way of the activities.

9. The method implementing the workflow definition tool described in claim 6, characterized in that: the step 4 sets an executor to every activity, determines a task operating interface, implements a task finishing manner and realizes task transmission operations.
